(19) United States
(12) Patent Application Publication
(10) Pub. No.: US 2004/0176981 A1
(43) Pub. Date: Sep. 9, 2004

(54) System architectures for computer aided detection (CAD) processor system

(76) Inventors: Edward A. Martello, Glenwood, MD (US); Jyh-Shyan Lin, North Potomac, MD (US); Fleming Y.-M. Lure, Potomac, MD (US); H.-Y. Michael Yeh, Potomac, MD (US)

Correspondence Address: VENABLE, BAETJER, HOWARD AND CIVILETTI, LLP, P.O. BOX 34385, WASHINGTON, DC, 20043-9998, US

(21) Appl. No.: 10/757,552

(22) Filed: Jan. 15, 2004

Related U.S. Application Data
(60) Provisional application No. 60/440,368, filed on Jan. 16, 2003.

(51) Int. Cl. G06F 17/60; G06K 9/54; G06K 9/00; G06K 9/60

(52) U.S. Cl. 705/2; 382/132; 382/305

(57) ABSTRACT

Radiological image processing equipment, for example, a computer-aided diagnosis (CAD) processor, may be interfaced with a communication network to permit images to be transmitted to the processing equipment and to permit results produced by the processing equipment to be transmitted to one or more destinations on the communication network.

### CROSS-REFERENCE TO RELATED APPLICATION

This application draws priority from U.S. Provisional Application No. 60/440,368, filed on Jan. 16, 2003, and hereby incorporated by reference in its entirety.

### BACKGROUND OF THE INVENTION

1. Field of the Invention

Embodiments of the present invention relate to system architectures for the processing of radiological images. More specifically, embodiments of the present invention relate to network-based architectures for interfacing image processing apparatus with image acquisition and/or display apparatus.

2. Related Art

The medical community has developed ways of sharing data, in particular image data, among its members in order to improve communication of information about patients and between medical professionals. The primary improvement in data sharing occurred with the implementation and adoption of the Digital Imaging and Communications in Medicine (DICOM) standard. The DICOM standard, currently in version 3.0, standardizes image file formats and commands across a networked environment.

Computer aided detection (CAD) systems use digital processing methods to assist users in identifying abnormalities from medical images. The CAD system is a computer system that receives a patient's diagnosis images such as, for example, x-ray images, pap smear images, mammograms, etc.; processes the patient's diagnosis images; and generates the CAD results indicating either potential abnormalities on specific locations (for example, the location of a disease) in the patients' diagnostic images. A physician or health care provider can then use the CAD results, along with other tools and information, to determine the location and condition of diseases for the patients.

Current diagnostic imaging and results-disseminating solutions do not take into account the provisions for patient confidentiality contained in the Health Insurance Portability and Accountability Act of 1996. For example, image file names routinely contain information that readily identifies the patient to whom the image corresponds. Further, imaging and CAD activities take place outside of the DICOM network, and images must be copied or moved to the network if they are to be shared.

Additionally, current diagnostic imaging processes are not robust in the event of real-time system failures, such as power failures or network failures. When failures occur, the CAD process must often be redone because there is no way to know which images have already been processed. The duplication of effort wastes time, resources and money.

What is needed then is a system that overcomes the shortcomings of conventional solutions.

### SUMMARY OF THE INVENTION

In an exemplary embodiment of the present invention a system for network-based computer aided detection (CAD) is disclosed.

An exemplary embodiment of the present invention combines CAD processing with a DICOM 3.0 Medical Imaging Network. The combination:

allows automatic processing to generate a CAD result; allows users to retrieve the images, after the CAD processing, directly from the DICOM network; allows the CAD processor to connect multiple film digitizers; allows the CAD processor to connect multiple computed radiograph (CR) image processors; and allows the CAD processor to connect multiple digital X-ray (DX) imaging systems. The technique may be extended to other imaging modalities and many disease types.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of various embodiments of the invention, as illustrated in the accompanying drawings wherein like reference numbers generally indicate identical, functionally similar, and/or structurally similar elements. The left most digit in the corresponding reference number indicates the drawing in which an element first appears.

FIG. 1 depicts an exemplary embodiment of a system of the present invention;

FIGS. 2A and 2B depict exemplary embodiments of the modules of the system according to the present invention;

FIG. 3 depicts an exemplary embodiment of the method of the present invention;

FIG. 4 depicts an exemplary embodiment of a recovery method according to the present invention; and

FIGS. 5A and 5B depict an exemplary embodiment of an image file name according to the present invention.

### DETAILED DESCRIPTION OF VARIOUS EMBODIMENTS OF THE INVENTION

Various embodiments of the invention are discussed in detail below. While specific exemplary embodiments are discussed, it should be understood that this is done for illustration purposes only. A person skilled in the relevant art will recognize that other components and configurations can be used without departing from the spirit and scope of the invention.

In an exemplary embodiment, the system combines a computer aided detection (CAD) processor with a communication network to streamline the CAD processing and distribution of diagnostic images. In the discussion below, the network being discussed is a DICOM-based network; however, the invention is not to be understood as being limited to this embodiment, and the network may be any appropriate network. The combination of CAD processing with communication network is implemented in such a way as to greatly improve the ability to recover from power or network failures. The overall input/output scheme between the network and the CAD processor is also designed to operate asynchronously, as CAD processing time may be greater than the peak image input rate, especially when more than one image modality port is present. The system is also designed to allow recovery from a power failure or other events that interrupt normal operation.

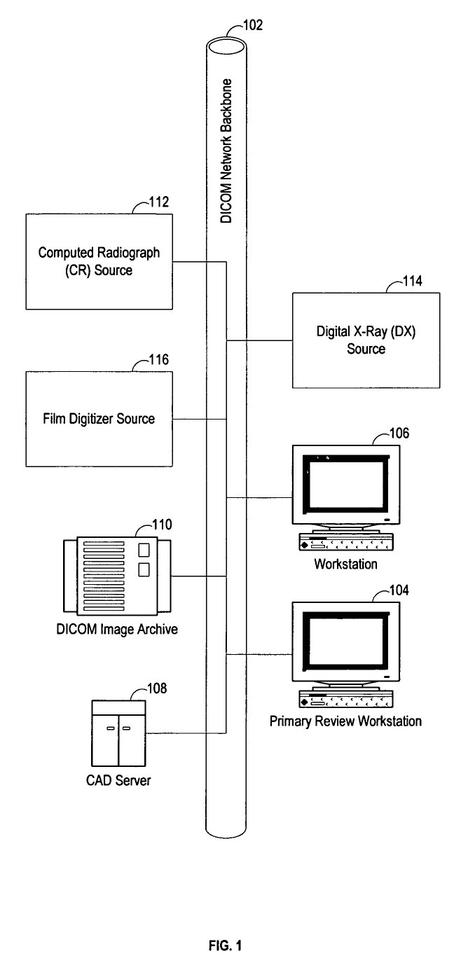

FIG. 1 depicts an exemplary embodiment of a system of the present invention. In particular, it shows the major functional elements of a minimum configuration of the CAD processor and the main control paths. The DICOM network backbone 102 can be coupled to a primary review workstation 104, one or more workstations 106, the CAD processor 108 and a DICOM image archive 110. The DICOM network can use, for example, the TCP/IP communications protocol. Possible image sources include devices that provide computed radiographs (CR) 112, digital X-rays (DX; also known as Digital Radiography, or DR) 114, and film digitization 116.

One or more network connections use the DICOM 3.0 standard protocols for medical image formatting and transmission. Multiple film scanners, computed radiograph image producing devices, digital radiography imagers, and servers or archive devices can be configured to connect to one or more CAD processors. The CAD processor may also use wireless mechanisms to receive images for processing.

The CAD processor receives images via a network connection using the DICOM 3.0 standard protocols for medical image formatting and transmission. The CAD processor normalizes the input images, performs complex and proprietary processing to detect nodules or other indications of disease on the images, and provides the results of the nodule detection to either the DICOM network node that sent the images and/or to a predetermined list of nodes.

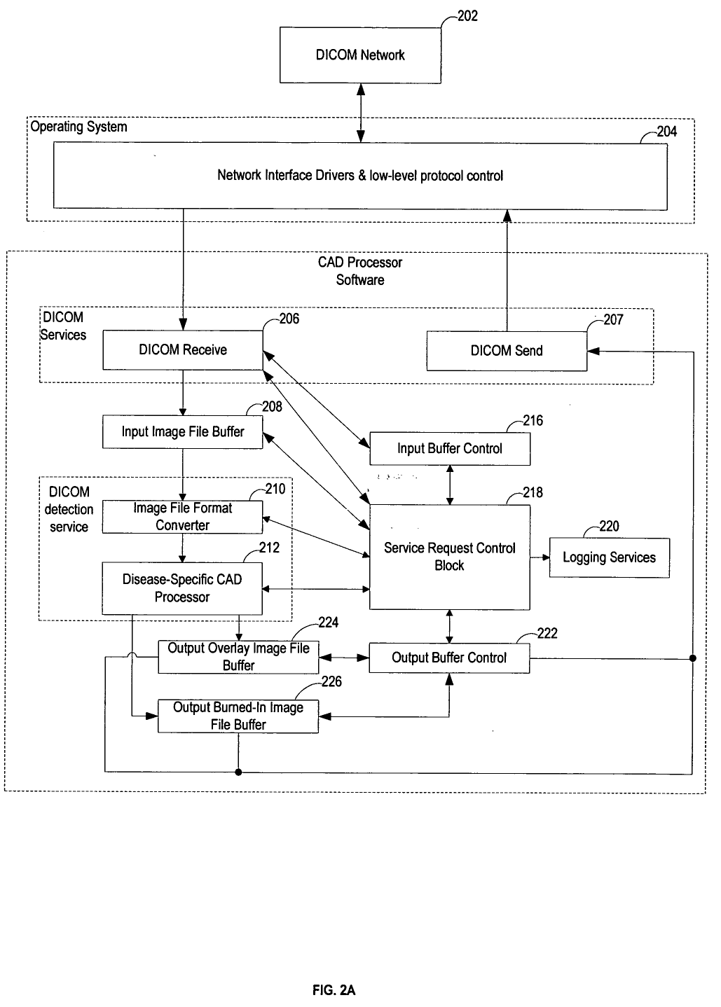

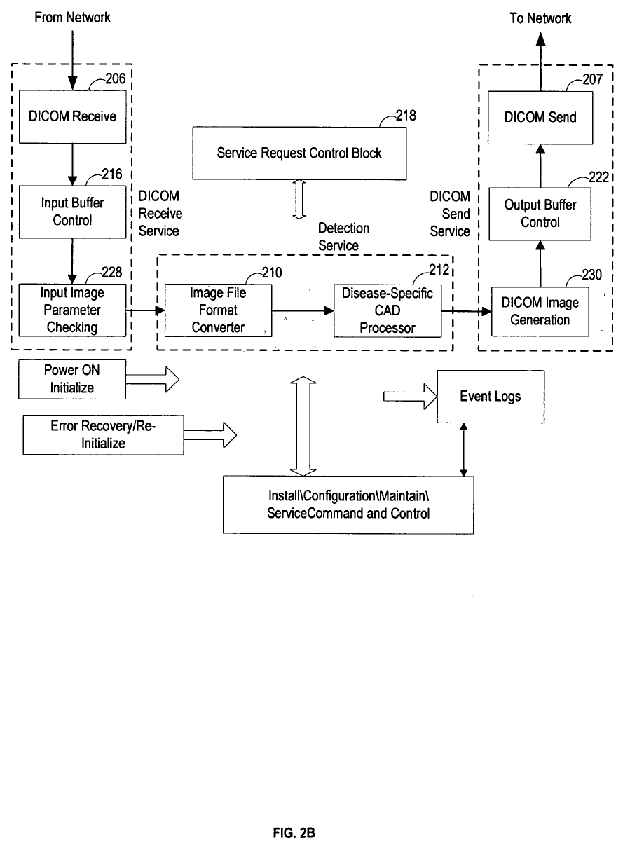

FIG. 2A is a block diagram showing an exemplary embodiment of the system of the present invention. The network interface block 204 is the software provided by the operating system to operate the network interface controller, which interfaces with the DICOM network 202. The TCP/IP communications protocol implementation is compatible with the DICOM 3.0 standard. The DICOM Receive Service 206 receives DICOM images generated by imaging modalities, generates asynchronous notifications to the image processing application upon receiving events, transmits images to configured and/or multiple destinations, allows the insertion of processed pixel information, allows the insertion of textual DICOM header information, allows the insertion of DICOM overlays, allows file parsing of locally stored DICOM images, allows file storage of generated DICOM images on local storage, and complies with DICOM 3.0 Conformance Statements for computed radiograph (CR), digital X-ray (DX), and secondary capture (SC) images and transfer criteria.

The image file format converter 210 receives image files from the input image file buffer 208 and works in concert with the DICOM receive service 206 and the service request control block 218 to handle input images, strip off the DICOM header of each image, adjust the size of each image to the number of rows and columns that are accepted by the disease-specific CAD processor 212 and also adjust the pixel depth (number of bits per pixel) to the range required by the CAD processor 212. The CAD processor 212 can be disease-specific, or it can detect multiple diseases. The stripped-off DICOM header is stored with its corresponding input image in the same format in which it is received, so all the necessary data in the header for evaluating and converting an image is available for the image file format converter 210.

Other functions of the image file format converter 210 can include byte swapping and converting from signed to unsigned values.

In an exemplary embodiment of the CAD processor 212, three detection results images can be generated: (1) a derived, full resolution image with regions of interest (e.g. the nodule locations) burned into the image; (2) a derived, reduced resolution image with regions of interest burned into the image; and (3) a full resolution image with a graphical result and/or location information supplied in an overlay plane. The output files with burned-in images are placed into the output burned-in image file buffer 226. The output files with the separate overlays are placed into the output overlay image file buffer 224. The DICOM Send Service 207 sends DICOM images to predetermined destinations on the DICOM network.

The service request control block 218 controls the reading of the image input buffer 208, the CAD processor 212, the output buffers 224 and 226, and other real-time operational functions of the CAD processor 212. The input buffer control 216 detects when the output buffer control 222 has indicated that the output buffers 224 and 226 are full and/or that the CAD processor 212 is busy. Logging services 220 captures status and error data output from the service request control block 218 during processing.

In an exemplary embodiment, the CAD processor 212 can read output images directly from the output buffers 224 and 226 and distribute the images automatically to predefined DICOM nodes on the DICOM network.

FIG. 2B is an alternate view of the same exemplary embodiment of the system of the present invention. This view emphasizes the roles of the three services contained within the CAD Processor Software (Receive, Detect, and Send). For example, the DICOM Receive Service, which can comprise the DICOM receive 206, the input buffer control 216 and the input image parameter checking 228, performs the input image parameter checking 228 before sending images to the Detection Service's image file format converter 210. Similarly, the DICOM Send Service, which can comprise the DICOM image generation 230, the output buffer control 222 and the DICOM send 207, performs DICOM image generation 230 on the results produced by the Detection Service's disease-specific CAD processor 212.

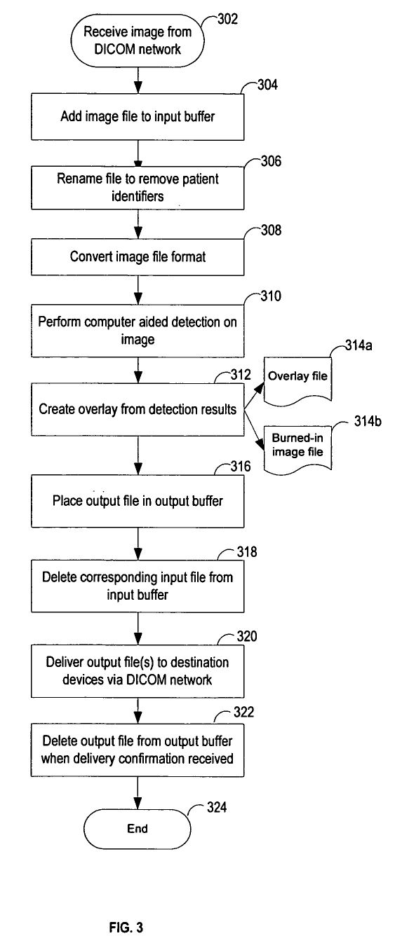

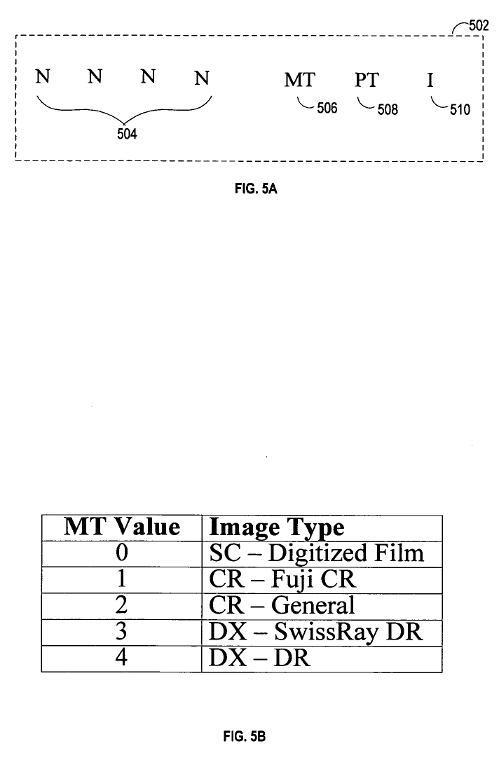

FIG. 3 depicts an exemplary embodiment of the method of the present invention. The system receives a medical image from the DICOM network in step 302. The image is then added by the DICOM service broker 206 to an input file buffer 208 in step 304. The input file buffer 208 is preferably a circular buffer. When full, the input file buffer 208 can overwrite the oldest images or reject any new images, depending on a parameter set by the user. The image file is then renamed in step 306 in order to remove any identifying patient information from the file name and also to create a unique file name, enabling asynchronous processing. The input image file name is discussed further in reference to FIGS. 5A and 5B.

Once renamed, the image file format is then converted in step 308. Incoming image files may be in several formats, and are converted into one single format for use in the CAD processor. After file format conversion, the CAD processor performs computer aided detection on the image in step 310, when the CAD software signals that it is ready to process an image. The CAD software will indicate that it is busy and cannot accept any input when it is processing an image and/or when there is no space to write an output image into the output buffers. Some exemplary processes of computer aided detection are described, for example, in U.S. application Ser. No. 09/625,418 entitled “Fuzzy Logic Based Classification (FLBC) Method for Automated Identification of Nodules in Radiological Images,” filed Jul. 25, 2000, now U.S. Pat. No. 6,654,728; in U.S. application Ser. No. 09/503,840 entitled “Divide-and-Conquer Method and System for the Detection of Lung Nodules in Radiological Images,” filed Feb. 15, 2000, now U.S. Pat. No. 6,549,646; in co-pending U.S. application Ser. No. 09/503,839 entitled “Automatic Method and System for the Detection of Lung Nodules in Radiological Chest Images Using Digital Image Processing and Artificial Neural Network,” filed Feb. 15, 2000; and in co-pending U.S. patent application Ser. No. 10/606,120, filed Jun. 26, 2003, all of common assignee, and incorporated herein by reference in their entirety.

Generally, the exemplary CAD software can perform multiple phases of image processing, neural network analysis, feature extraction, and fuzzy logic processing to identify regions of interest (ROI) indicating the potential areas of disease from various image types. The detection software can be supplied as a standard library (.DLL, .OCX, LIB, etc.) with a common application programming interface (API) for easy integration.

From the detection results, the CAD processor creates an overlay file indicating any ROI in step 312. The overlay information can be kept separate from the original file in overlay output file 314a, or the overlay information can be burned into the original file in burned-in image file 314b. The output files are then placed in their appropriate output buffers in step 316. As discussed above, the overlay output file has a separate buffer 224 from the burned-in image files, which go into burned-in image file buffer 226.

When an output file is placed in the output buffer, the corresponding unprocessed input file is deleted from the input buffer in step 318. Then, the output file is delivered to its destination via the DICOM network in step 320. Examples of destinations include, but are not limited to, review workstations, storage archives, etc. The service request control block 218 will delete the associated output image from the output buffer when the DICOM service broker signals successful transmission of the file to its destination(s) in step 322. Processing is finished at end-block 324.

Accordingly, at any point in time, the input buffer will contain only images that require processing, and the output buffers will contain only processed images that have not be sent. When the system is idle, there are no images in the input or output buffers. Maintaining the buffers in this manner improves the efficiency of the system in the event of a failure because the system will not need to reprocess any images.

To improve the robustness of the system, the service request control block 218 stores the value of the image that is being processed or that was last processed if the processor is idle. The service request control block 218 can also store an up/down counter that counts up the number of images input and counts down each time an image is processed. The values may be stored, for example, in a temporary file, in an operating system registry file, such as the Microsoft Windows® operating system registry, or both. The count value can always be verified by a startup routine and/or an error checking routine that counts the number of files remaining in the input buffer. A similar counter and checking scheme can control the output buffers. The actual file names in the input and output buffers can be compared, and by testing the various matches and mismatches that exist, the state of the CAD processor at the time of any failure can be deduced.

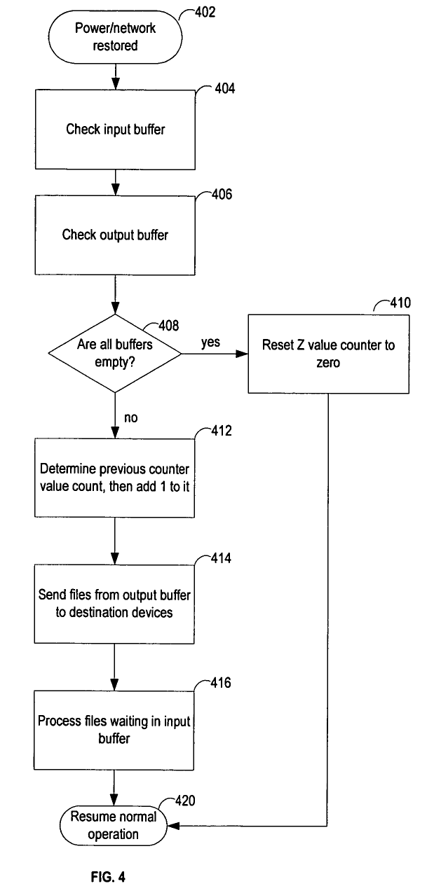

FIG. 4 is a flowchart for the method of recovery according to the present invention. When the failure, either power or network, is resolved in step 402, the processor initialization module checks the contents of the input buffer in step 404 and of the output buffer in step 406. If both buffers are empty, in step 408, a counter Z used to generate filenames is reset to zero in step 410, and the system can resume normal operation in step 420. If the buffers are not empty, the system determines the highest Z value count used before the system abnormally terminated and sets the new count value to this maximum value plus one in step 412. Next, any files waiting in the output file buffer are sent to their destinations in step 414. Then any files waiting in the input file buffer are CAD-processed in step 416. From there, normal operation of the system can resume in step 420.

FIGS. 5A and 5B depict an exemplary embodiment of an image file name according to the present invention. The DICOM service broker 206 assigns a unique non-repeating number or value as a file name for the input image as it is written into an input buffer folder on disk and uses that same number or value to name the output files in their respective buffers. The value of the file name allows asynchronous image input, asynchronous CAD detection and asynchronous output of an overlay image and a derived image with burned in ROI.

The input image file name 502 can be constructed as shown in FIG. 5A. The N value 504 is a four-digit decimal number that increments by one for each input image placed into the input buffer by the DICOM Receive Service. The N value is reset to zero at system power on or at reboot if all input and output buffers are empty. The PT value 508 is a one digit decimal number of the modality port that supplied the input image. The MT value 506 is a one digit decimal number that encodes the type of imaging modality that supplied the input image. FIG. 5B shows a suggested example of codes. For example, an MT value of 0 could mean that the image is on digitized film. The “I” in field 510 indicates that this file is an input file.

Output file names preferably have the same format as input image file names, except that instead of an “I” in field 510 at the end of the file name, the full resolution output image file name has an “F”, indicating that the file is a full resolution output image with ROI coordinate information in an overlay plane. The N, MT and PT values are the exact values copied from the corresponding input image that resulted in the output image. The derived image file name, instead of having an “I”, can have a “D”, indicating that the file is a reduced resolution output image with ROI marks burned into the image. The N, MT and PT values are, again, the exact values copied from the corresponding input image that resulted in the output image.

Note that various embodiments of the invention may be implemented in the form of hardware, software, firmware, etc., or combinations thereof. As an example, embodiments of the invention may be implemented as software code embodied on a machine-readable medium. Examples of such a machine-readable medium include, but are not limited to, a hard disk, a floppy disk, semiconductor or other types of memory, a CD, a DVD, RAM, ROM, a modulated communication signal, etc. Embodiments of the invention may also be implemented in the form of a computer system, having at least one processor, adapted to perform a method according to an embodiment of the invention.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. Apparatus for interfacing radiological image processing equipment with a communication network, comprising:
a receive interface coupled to said communication network, the receive interface adapted to receive one or more input radiological images from said communication network and to pass them to said radiological image processing equipment;
a transmit interface coupled to said communication network, the transmit interface adapted to transmit processed radiological image information from said radiological image processing equipment through said communication network; and
control logic coupled to said receive interface and to said transmit interface, and to said radiological image processing equipment, the control logic adapted to coordinate operation of said receive interface, said transmit interface, and said radiological image processing equipment.

2. The apparatus according to claim 1, further comprising:
an input buffer coupled to said receive interface and to said control logic, the input buffer being adapted to store input radiological images received by said receive interface prior to passing them to said radiological image processing equipment.

3. The apparatus according to claim 1, further comprising:
an image file format converter adapted to receive input radiological images and to remove non-image information from the input radiological images prior to passing the input radiological images to said radiological image processing equipment.

4. The apparatus according to claim 1, further comprising:
at least one output buffer coupled to said transmit interface and to said control logic and adapted to store processed radiological image information prior to transmitting the processed radiological image information through said communication network.

5. The apparatus according to claim 4, wherein said at least one output buffer comprises:
an overlay image buffer; and
a burned-in image buffer.

6. The apparatus according to claim 1, wherein said control logic comprises:
input control logic adapted to coordinate reception and initial processing of input radiological images; and
output control logic adapted to coordinate output processing and transmission of processed radiological image information.

7. The apparatus according to claim 6, wherein said control logic is further adapted to log information about processing of radiological images.

8. The apparatus according to claim 1, further comprising:
at least one input buffer; and
at least one output buffer; and
wherein said control logic comprises error recovery logic coupled to said input and output buffers and adapted to check contents of said input and output buffers and to base recovery at least in part on said contents of at least one of said input and output buffers.

9. The apparatus according to claim 1, wherein said control logic is adapted to check parameters of said input radiological images.

10. A system for processing radiological images, comprising:
one or more radiological image sources, each coupled to a communication network and adapted to transmit radiological images over said communication network;
the apparatus according to claim 1, also coupled to said communication network; and
radiological image processing equipment coupled to said apparatus.

11. The system according to claim 10, wherein the communication network is adapted to comply with DICOM standard protocols.

12. The system according to claim 10, wherein said radiological image processing equipment comprises a computer-aided detection (CAD) processor.

13. A method of interfacing radiological image processing equipment with a communication network, the method comprising:
buffering each input radiological image received from said communication network in an input buffer;
converting a format of said input radiological image to create a reformatted radiological image;
providing said reformatted radiological image to said radiological image processing equipment; and
buffering output from said radiological image processing equipment.

14. The method according to claim 13, wherein said converting a format comprises:
removing non-image data from said input radiological image.

15. The method according to claim 13, wherein said converting a format comprises:
renaming a file containing said input radiological image.

16. The method according to claim 13, wherein said output from said radiological image processing equipment comprises at least one of overlay output and burned-in image output, and wherein said buffering output comprises buffering overlay output in an overlay output buffer and buffering burned-in image output in a burned-in image output buffer.

17. The method according to claim 13, further comprising:
removing an input radiological image corresponding to buffered output from said radiological image processing equipment from said input buffer.

18. The method according to claim 13, further comprising:
transmitting buffered output from said radiological image processing equipment to at least one destination; and
deleting the buffered output that was transmitted after receiving at least one acknowledgment from said at least one destination.

19. The method according to claim 13, further comprising:
logging at least one of status and error data.

20. The method according to claim 13, further comprising:
assigning a file name to a file representing an input radiological image based on at least one of a counter and an image type.

21. The method according to claim 13, further comprising a method of recovery, comprising:
checking said input buffer;
checking an output buffer in which said buffering output buffers said output;
resetting a file naming counter to zero if said input buffer and said output buffer are both empty; and
incrementing said file naming counter from a previous counter value if at least one of said input buffer and said output buffer is not empty.

22. The method according to claim 21, said method of recovery further comprising:
transmitting output from said output buffer if said output buffer is not empty; and
processing contents of said input buffer if said input buffer is not empty.

23. The method according to claim 13, wherein said radiological image processing equipment comprises a computer-aided detection (CAD) processor.

24. A method of processing radiological images over a communication network, comprising:
transmitting over said communication network at least one radiological image from an image source to a processing apparatus implementing the method according to claim 13; and
transmitting, from said processing apparatus to at least one destination over said communication network, output from said radiological image processing equipment buffered during said buffering output.

25. A computer-readable medium containing software code that, when executed by a processor, performs the method according to claim 13.

26. A computer system adapted to perform the method according to claim 13.
